(19) United States
(12) Patent Application Publication
(10) Pub. No.: US 2020/0394606 A1
(43) Pub. Date: Dec. 17, 2020

(54) DETECTING DELIVERY STATUS BASED ON GEO-FENCING

(71) Applicant: Postmates Inc., San Francisco, CA (US)

(72) Inventor: Yiqing Fan, San Bruno, CA (US)

(73) Assignee: Postmates Inc., San Francisco, CA (US)

(21) Appl. No.: 16/443,865

(22) Filed: Jun. 17, 2019

(51) Int. Cl. G06Q 10/08

(52) U.S. Cl. CPC G06Q 10/0833; G06Q 10/0832

(57) ABSTRACT

Techniques described in this application are directed to facilitating delivery of an item through improved notifications. One or more geographical boundaries may assist with detection of status identifiers corresponding with delivery of the item at various points of time.

### CROSS-REFERENCES TO RELATED APPLICATIONS

The present application is related to U.S. Non-Provisional Patent Application No. ______ [Attorney Docket No. 104584-1139020] and U.S. Non-Provisional Patent Application No. ______ [Attorney Docket No. 104584-1139030]; each of which is incorporated by reference in its entirety for all purposes.

### BACKGROUND OF THE INVENTION

Some route monitoring systems are implemented to improve a traversal of the path from a first location to a second location. By adding an item to be delivered in association with the route monitoring systems, these systems can provide an item along the shortest path in an attempt to provide the item in the shortest timeframe. However, delivery issues may occur that may be irrelevant to finding a shortest or quickest path between the two locations, including traffic, weather, road blocks, vehicle damages, payment issues at a merchant location, software device issues, and the like. Additionally, delivery issues may occur due to the nature or perishability of the item, which can affect the overall route optimization and adjust the goals of the system. As such, item delivery systems need improvement, including functionality to proactively stop issues from derailing delivery of the item or causing the item to spoil.

### BRIEF SUMMARY OF THE INVENTION

One aspect of the present disclosure relates to systems and methods for facilitating delivery of one or more items. For example, the disclosure may include a computer-implemented method comprising: receiving, by a tracking computer system, an order notification for an item associated with a consumer user device located at a consumer location, wherein the item is located at a merchant location, wherein a merchant user device is located at the merchant location; providing, by the tracking computer system, an electronic offer to transport the item from the merchant location to the consumer location; receiving, by the tracking computer system, an acceptance of the electronic offer from a fleet user device, wherein a location of the fleet user device corresponds to a movable location identified by a positioning system; upon receiving the acceptance of the electronic offer, updating, by the tracking computer system, a status of the item to a first status identifier of a plurality of status identifiers, wherein the first status identifier corresponds to a pickup started identifier; receiving, by the tracking computer system, a first locator notification when the movable location of the fleet user device enters a first geographical boundary of a plurality of geographical boundaries, wherein the first geographical boundary is associated with the merchant location; upon receiving the first locator notification, updating, by the tracking computer system, the status of the item to a second status identifier of the plurality of status identifiers, wherein the second status identifier corresponds to a pickup imminent identifier; receiving, by the tracking computer system, a second locator notification when the movable location of the fleet user device exits the first geographical boundary; upon receiving the second locator notification, updating, by the tracking computer system, the status of the item to a third status identifier of the plurality of status identifiers, wherein the third status identifier corresponds to a drop-off started identifier; receiving, by the tracking computer system, a third locator notification when the movable location of the fleet user device enters a second geographical boundary of the plurality of geographical boundaries, wherein the second geographical boundary is associated with the consumer location; and upon receiving the third locator notification, updating, by the tracking computer system, the status of the item associated with the consumer user device to a fourth status identifier corresponding to a drop-off imminent identifier.

In some examples, the computer-implemented method further comprises: generating an order update notification associated with the plurality of status identifiers; and transmitting the order update notification to the consumer user device. In some examples, the electronic offer to transport the item from the merchant location to the consumer location is provided directly to the fleet user device. In some examples, the electronic offer to transport the item from the merchant location to the consumer location is provided to an electronic message board accessible by the fleet user device. In some examples, the item is a food item. In some examples, the merchant user device initiates a transmission of the first locator notification when the movable location of the fleet user device enters the first geographical boundary. In some examples, the consumer user device initiates a transmission of the third locator notification when the movable location of the fleet user device enters the second geographical boundary.

Another aspect of the disclosure comprises a tracking computer system comprising: one or more processors; and a non-transitory computer-readable medium including instructions that, when executed by the one or more processors, cause the one or more processors to: receive an order notification for an item associated with a consumer user device located at a consumer location, wherein the item is located at a merchant location, wherein a merchant user device is located at the merchant location; provide an electronic offer to transport the item from the merchant location to the consumer location; receive an acceptance of the electronic offer from a fleet user device, wherein a location of the fleet user device corresponds to a movable location identified by a positioning system; upon receiving the acceptance of the electronic offer, update a status of the item to a first status identifier of a plurality of status identifiers, wherein the first status identifier corresponds to a pickup started identifier; receive a first locator notification when the movable location of the fleet user device enters a first geographical boundary of a plurality of geographical boundaries, wherein the first geographical boundary is associated with the merchant location; upon receiving the first locator notification, update the status of the item to a second status identifier of the plurality of status identifiers, wherein the second status identifier corresponds to a pickup imminent identifier; receive a second locator notification when the movable location of the fleet user device exits the first geographical boundary; upon receiving the second locator notification, update the status of the item to a third status identifier of the plurality of status identifiers, wherein the third status identifier corresponds to a drop-off started identifier; receive a third locator notification when the movable location of the fleet user device enters a second geographical boundary of the plurality of geographical boundaries, wherein the second geographical boundary is associated with the consumer location; and upon receiving the third locator notification, update the status of the item associated with the consumer user device to a fourth status identifier corresponding to a drop-off imminent identifier.

In some examples, the instructions further cause the one or more processors to: generate an order update notification associated with the plurality of status identifiers; and transmit the order update notification to the consumer user device. In some examples, the electronic offer to transport the item from the merchant location to the consumer location is provided directly to the fleet user device. In some examples, the electronic offer to transport the item from the merchant location to the consumer location is provided to an electronic message board accessible by the fleet user device. In some examples, the item is a food item. In some examples, the merchant user device initiates a transmission of the first locator notification when the movable location of the fleet user device enters the first geographical boundary. In some examples, the consumer user device initiates a transmission of the third locator notification when the movable location of the fleet user device enters the second geographical boundary.

Another aspect of the disclosure comprises a non-transitory computer-readable storage medium storing a plurality of instructions executable by one or more processors, the plurality of instructions when executed by the one or more processors cause the one or more processors to: receive an order notification for an item associated with a consumer user device located at a consumer location, wherein the item is located at a merchant location, wherein a merchant user device is located at the merchant location; provide an electronic offer to transport the item from the merchant location to the consumer location; receive an acceptance of the electronic offer from a fleet user device, wherein a location of the fleet user device corresponds to a movable location identified by a positioning system; upon receiving the acceptance of the electronic offer, update a status of the item to a first status identifier of a plurality of status identifiers, wherein the first status identifier corresponds to a pickup started identifier; receive a first locator notification when the movable location of the fleet user device enters a first geographical boundary of a plurality of geographical boundaries, wherein the first geographical boundary is associated with the merchant location; upon receiving the first locator notification, update the status of the item to a second status identifier of the plurality of status identifiers, wherein the second status identifier corresponds to a pickup imminent identifier; receive a second locator notification when the movable location of the fleet user device exits the first geographical boundary; upon receiving the second locator notification, update the status of the item to a third status identifier of the plurality of status identifiers, wherein the third status identifier corresponds to a drop-off started identifier; receive a third locator notification when the movable location of the fleet user device enters a second geographical boundary of the plurality of geographical boundaries, wherein the second geographical boundary is associated with the consumer location; and upon receiving the third locator notification, update the status of the item associated with the consumer user device to a fourth status identifier corresponding to a drop-off imminent identifier.

In some examples, the instructions further cause the one or more processors to: generate an order update notification associated with the plurality of status identifiers; and transmit the order update notification to the consumer user device. In some examples, the electronic offer to transport the item from the merchant location to the consumer location is provided directly to the fleet user device. In some examples, the electronic offer to transport the item from the merchant location to the consumer location is provided to an electronic message board accessible by the fleet user device. In some examples, the item is a food item. In some examples, the merchant user device initiates a transmission of the first locator notification when the movable location of the fleet user device enters the first geographical boundary.

### BRIEF DESCRIPTION OF THE DRAWINGS

FIG. 1 is a block diagram illustrating an example of a tracking computer system in a distributed network according to an embodiment of the disclosure.

FIG. 2 is a block diagram illustrating an example of a tracking computer system according to an embodiment of the disclosure.

FIG. 3 is a block diagram illustrating an example of a fleet user device according to an embodiment of the disclosure.

FIG. 4 is a block diagram illustrating an example of a consumer user device according to an embodiment of the disclosure.

FIG. 5 is a block diagram illustrating an example of a merchant user device according to an embodiment of the disclosure.

FIG. 6 is a database schema illustrating a plurality of data values according to an embodiment of the disclosure.

FIG. 7 is an illustrative process for facilitating a delivery of an item according to an embodiment of the disclosure.

FIG. 8 is an illustrative process for determining status identifiers during a delivery of an item according to an embodiment of the disclosure.

FIG. 9 is an illustrative map of geographic locations according to an embodiment of the disclosure.

FIG. 10 is an illustrative database associated with status identifiers according to an embodiment of the disclosure.

FIG. 11 is an illustrative database of status identifiers according to an embodiment of the disclosure.

FIG. 12 is an illustrative item data according to an embodiment of the disclosure.

FIG. 13 illustrates notifications transmitted to a consumer user device according to an embodiment of the disclosure.

FIG. 14 illustrates notifications transmitted to a fleet user device according to an embodiment of the disclosure.

### DETAILED DESCRIPTION OF THE INVENTION

The description provided herein includes illustrative embodiments only and is not intended to limit the scope, applicability, or configuration of the disclosure. Rather, the description will provide those skilled in the art with an enabling description for implementing a preferred exemplary embodiment. It is understood that various changes can be made in the function and arrangement of elements without departing from the scope as set forth in the claims.

Embodiments of the application describe various improvements to systems, methods, and devices throughout a communication network to facilitate delivery of an item by correlating context, data, and timing with action predictions. For example, the tracking system can identify the location of one or more user devices, including a fleet user device, consumer user device, and a merchant user device. In some examples, the time and location of the fleet user device can be analyzed to predict a status of a delivery of an item, absent an explicit status update associated with the delivery. For example, when the fleet user device enters a threshold distance of a merchant location, the fleet user device may imminently pickup an item for delivery from the merchant location. When the fleet user device exits the threshold distance from the merchant location, the fleet user device may have initiated a drop-off portion of the delivery of the item to a consumer location. When the fleet user device maintains a location within a geographical boundary associated with the merchant location for a certain period of time, a status identifier may be established to predict a potentially negative issue with facilitating delivery of the item. Additional electronic actions may be taken to resolve the issue prior to significantly extending an estimated delivery time of the item.

In some embodiments, the system can correlate a plurality of data streams and compare the additional data with a status of a delivery of an item. The status of the delivery may include various identifiers, including pickup started identifier, pickup imminent identifier, drop-off started identifier, or drop-off imminent identifier. The receipt of data from the data stream can help identify different issues from the data. For example, the pickup started identifier may be activated when a fleet user device is correlated with delivery of the item. The system can identify that the fleet user device has not moved. Depending on the status identifier associated with a current location of an item and based on various data streams, the movable location of the fleet user device may help the system determine if there is or is not an issue. The delivery of the item may be reassigned so that the item may be delivered within a given estimated time of arrival (ETA). In some examples, a push notification may be transmitted to request additional data streams from user devices involved with delivery of the item.

When the ETA is at risk of being adjusted or misrepresented, the system can determine an amount of risk based on an analysis of a plurality of data streams. By analyzing the plurality of data streams, the system can assess the risk of an issue prior to an explicit notification of an issue with delivery of the item. For example, the system may determine how much time it should take from the movable location of the fleet user device to reach the merchant or consumer location, taking into account additional data proactively.

Various technical improvements to conventional systems are identified by the disclosure. For example, conventional systems may receive an order for an item from a consumer and provide delivery of the item to the consumer location. Other conventional systems may rely on a tracking device on the item, including a barcode or other identifier that must be scanned to identify the location of the item on a delivery route. Some embodiments of the application may not require a tracking device on the item. Improvements may also be realized by analyzing multiple data streams to proactively identify issues with the delivery of the item absent a requirement of scanning item. By analyzing these data streams, any potential issues can be identified and proactively solved prior to the issue affecting the delivery of one or more items.

Additionally, the multiple data streams may be available for other purposes and reused for the identification of issues associated with delivery of the item. By relying on multiple data streams, additional electronic communication transmissions that identify the location of the item can be reduced between the tracking computer system and one or more user devices. The multiple data streams may also be used to supplement or replace user input and help generate a more electronically efficient system.

The technical improvements may also correspond with the perishable nature of items being transported. For example, conventional systems may transport non-perishable items with extended limits on time constraints. An ETA deadline that is missed with conventional systems may not affect the item, whereas a perishable item may become unusable and/or frustrate the consumer. When perishable items are transported, the system described herein may factor in freshness of the item. The system may account for the physical transportation of item to maintain freshness of the item in association with an expedited timeline, and in some examples, rely on additional data streams to identify and resolve a delivery issue prior to affecting the freshness and usability of the perishable item.

The technical improvements may also correspond with some implementation features of the system. For example, conventional systems may rely on a single system or even a plurality of subsystems that communicate synchronously to perform actions by the system overall. In some embodiments of application, individual processes and features may be co-located or distributed among subsystems such that when the communication pipeline corresponding with actions performed by one subsystem is full, other subsystems may receive the asynchronous communications and perform actions on behalf of the busy subsystem. In some embodiments, the system may be decoupled into two or more systems and the subsystems may communicate via one or more data streams upon availability of a processing pipeline for the subsystem.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will be described in more detail below in the following specification, claims, and accompanying drawings.

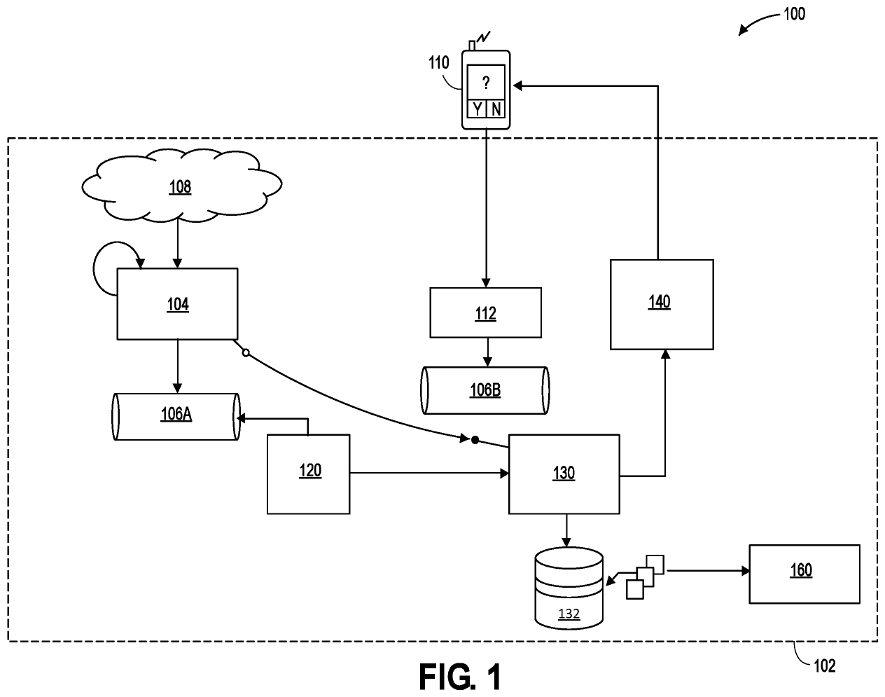

FIG. 1 is a block diagram illustrating an example of a tracking computer system in a distributed network according to an embodiment of the disclosure. In example 100, a distributed system is illustrated, including a tracking computer system 102 and a fleet user device 110. In some examples, systems illustrated herein may comprise a mixture of physical and cloud computing components. Each of these devices may transmit electronic messages via a communication network, either synchronously or asynchronously. Names of these and other computing devices are provided for illustrative purposes and should not limit implementations of the disclosure.

Tracking computer system 102 may correspond with various aspects of facilitating delivery of an item from a merchant location to a consumer location. One or more of these systems may each correspond with one or more databases to store data to implement functionality described herein. Various embodiments of the specialized tracking computer system 102 are available without diverting from essence of the disclosure.

Tracking computer system 102 may include one or more systems that may be independent to help generate functionality of facilitating delivery of the item from a merchant location to a consumer location. The one of more systems may create micro services or micro applications and interact through electronic communications with other systems of tracking computer system 102 to receive, maintain, and transmit data between the systems provided in the simplified illustration 100.

These systems may interact through one or more synchronous or asynchronous communications. For example, the systems in illustration 100 may write an electronic communication to one or more data streams 106 to provide communications to other systems asynchronously. These systems may receive the information from the one or more data streams 106 upon availability for processing. This communication method may be beneficial when one or more of the systems are off-line or busy processing other actions. In other examples, the systems in illustration 100 may communicate directly with other systems synchronously, or through direct calls and direct communications, to perform actions described herein.

Tracking computer system 102 may include a delivery system 104. The delivery system may be configured to detect one or more delivery issues associated with an item or fleet user device. For example, delivery system 104 may identify a movable location of a fleet user device and compare the movable location and/or time duration associated with the movable location with one or more threshold values. When the time duration, for example, exceeds the threshold value, delivery system 104 may write an electronic communication (e.g., ticket, status identifier, item identifier, etc.) to one or more data streams 106. Upon availability for processing, ticketing system 160 may receive the electronic communication and generate a status identifier associated with the potential delivery issue.

Delivery system 104 may also be configured to receive information about existing active status identifiers and/or delivery issues to help resolve the delivery issue. In some examples, delivery system 104 is configured to respond to active status identifiers and communicate with other systems to initiate one or more actions associated with the status identifier.

Tracking computer system 102 may include one or more data streams 106 (illustrated as data stream 106A and 106B). In illustration 100, delivery system 104 and secondary application 120 may write electronic communications to the one or more data streams to perform actions by other systems associated with tracking computer system 102. When a system is available to accept an additional action, including delivery system 104, the system may access one or more data streams 106 to receive an action to perform. In some examples, one or more data streams 106 may be de-duplicated by one of the systems associated with tracking computer system 102.

Tracking computer system 102 may include a fleet metrics system 108. Fleet metrics system 108 may be configured to receive and maintain data associated with a fleet user device. Fleet user information may correspond with a database of movable locations of the fleet user device, including a geolocation from a positioning system, one or more electronic offers that have been accepted by the fleet user (e.g., prior to or after transporting the item to the consumer location, etc.), electronic communications transmitted to the fleet user device via fleet API 112, and the like. One or more systems may communicate with fleet metrics system 108 to receive fleet user data.

The tracking computer system 102 may include a secondary application 120. Secondary application 120 may be configured to facilitate communications between the systems by reading and/or writing electronic communications directly to the asynchronous data stream 106. In some examples, secondary application 120 may transmit one or more electronic communications to a help center service 130, including to record one or more delivery issues and/or status identifiers for delivery of an item.

In some examples, the tracking computer system 102 may not use help center service 130. For example, electronic communications may be routed to ticketing system 160 to create tickets, which may be analyzed and processed automatically or manually (e.g., using support agents).

Help center service 130 may receive an API call associated with a delivery issue or other status identifier, and place the electronic communication in a processing queue 132. Processing queue 132 may correspond with a top processor which ranks electronic communications at a specific interval to identify relative urgency of status identifiers provided to help center service 130. Help center service 130 and/or ticketing system 160 may receive the ranked electronic communications and attempt to resolve any delivery issues in the order identified by processing queue 132.

Tracking computer system 102 may include an order management subsystem 140. Order management subsystem 140 may be configured to identify information about physical transportation of items, information associated with one or more fleet users, or information associated with items from one or more merchant users. In some examples, order management subsystem 140 may create a data structure associated with physical transportation of an item and maintain contacts of users associated with the item, including a fleet user, consumer user, or merchant user. In some examples, order management subsystem 140 may electronically identify a transportation of the item to be completed in one or more data streams 106, databases, or ticketing system 160.

Tracking computer system 102 may include a ticketing system 160. Ticketing system 160 may be implemented internally with tracking computer system 102 or externally as a service. Ticketing system 160 may be configured to create a delivery issue and/or status identifier, or transmit a push notification or other electronic communication to a fleet user device 110 via fleet API 112.

Tracking computer system 102 may perform several actions through these and other subsystems described throughout the disclosure. For example, delivery system 104 may identify an action to provide an electronic offer to transport an item. Delivery system 104 may write an electronic communication corresponding with this action to one or more data streams 106. When the system is available, fleet API 112 may asynchronously receive the action from data stream 106 and transmit the electronic offer to fleet user device 110.

In another illustrative example, delivery system 104 may identify a delivery issue associated with a fleet user device 110. Delivery system 104 may write an electronic communication to one or more data streams 106, which may be received by help center service 130 and/or ticketing system 160. Ticketing system 160 then generates a status identifier corresponding with the delivery issue. Help center service 130 may identify the electronic communication and attempt to resolve the potential delivery issue using processes described herein.

In another illustrative example, one or more subsystems may provide duplicative processing. For example, delivery system 104 and ticketing system 160 may duplicate functionality of secondary application 120 and one or more data streams 106. The redundancy, in some embodiments, may provide an increased amount of uptime to provide increased functionality to user devices to further facilitate delivery of the item.

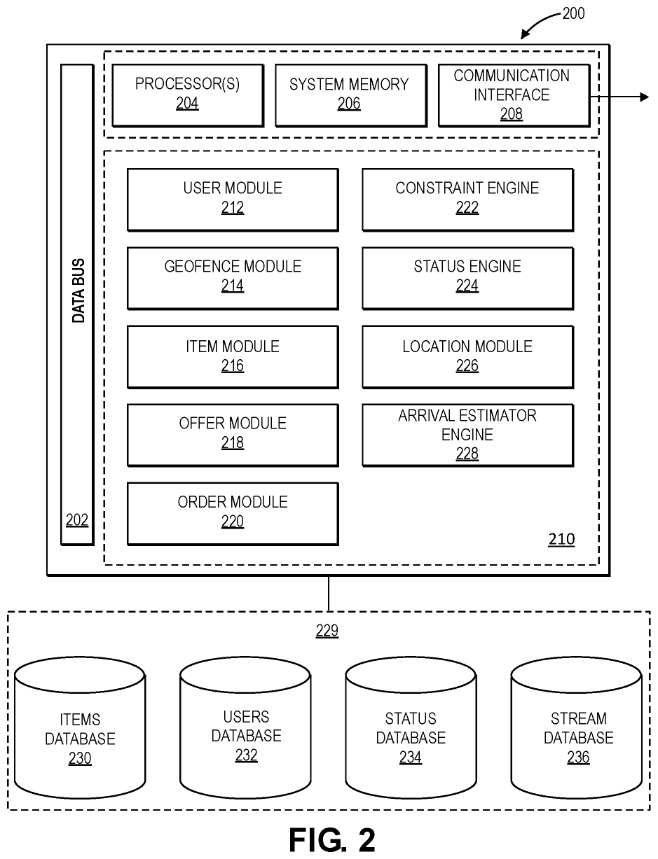

FIG. 2 is a block diagram illustrating an example of a tracking computer system 200 according to an embodiment of the disclosure. For example, tracking computer system 200 may comprise hardware and software components to facilitate delivery of an item from a merchant location to consumer location via a fleet user device in a distributed network. The illustration of tracking computer system 200 of FIG. 2 may be in addition to or an alternative of the illustration of tracking computer system 102 of FIG. 1.

Tracking computer system 200 may correspond with any number of computing devices or servers on a distributed network, including one or more processors 204 that communicate with a number of peripheral subsystems via data bus 202. These peripheral subsystems may include a system memory 206, communication interface 208, computer readable storage medium 210, and/or one or more databases 229.

Data bus 202 provides a mechanism for allowing the various components and subsystems of tracking computer system 200 to communicate with each other. Although data bus 202 is shown schematically as a single bus, alternative embodiments of data bus 202 may utilize multiple buses. Data bus 202 may be several types of bus structures, including a memory bus or memory controller bus, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

One or more processors 204 may control the operation of tracking computer system 200 and may comprise one or more application specific integrated circuits (ASICs) or field programmable gate arrays (FPGAs). Processors 204 may include single core and/or multicore processors. The processing resources of tracking computer system 200 may be organized into one or more processing units. A processing unit may include one or more processors, one or more cores from the same or different processors, a combination of cores and processors, or other combinations of cores and processors. In some embodiments, one or more processors 204 may include one or more special purpose co-processors such as graphics processors, digital signal processors (DSPs), or the like. In some embodiments, some or all of the processing units of one or more processors 204 may be implemented using customized circuits.

In some embodiments, one or more processors 204 may execute instructions stored in system memory 206 or on computer readable storage media 210. In various embodiments, one or more processors 204 may execute a variety of programs or code instructions and may maintain multiple concurrently executing programs or processes. At any given time, some or all of the program code to be executed may be resident in system memory 206 and/or on computer readable storage media 210 including potentially on one or more storage devices. Through suitable programming, one or more processors 204 may provide various functionalities described above. In instances where tracking computer system 200 is executing one or more virtual machines, one or more processors 204 may be allocated to each virtual machine.

System memory 206 may store program instructions that are loadable and executable on one or more processors 204, as well as data generated during execution of programs. Depending on the configuration and type of tracking computer system 200, system memory 206 may be volatile (e.g., random access memory (RAM), etc.) and/or non-volatile (e.g., read-only memory (ROM), flash memory, etc.). Tracking computer system 200 may also include additional removable storage and/or non-removable storage including, but not limited to, magnetic storage, optical disks, and/or tape storage. The disk drives and associated computer-readable media may provide non-volatile storage of computer-readable instructions, data structures, program modules, and other data for tracking computer system 200. In some implementations, system memory 206 may include multiple different types of memory, such as static random access memory (SRAM), dynamic random access memory (DRAM), solid-state drive (SSD), or ROM.

Tracking computer system 200 may include a communication interface 208. Communication interface 208 provides an interface to other computer systems and networks and may serve as an interface for receiving data from and transmitting data to other systems or user devices. For example, communication interface 208 may enable tracking computer system 200 to establish a communication channel to one or more user devices via the external communication network for receiving and sending information to and from user devices.

Communication interface 208 may support both wired and/or wireless communication protocols. For example, in certain embodiments, communication interface 208 may include radio frequency (RF) transceiver components for accessing wireless voice and/or data networks. This may include using cellular telephone technology, advanced data network technology, such as 3G, 4G, EDGE (enhanced data rates for global evolution), WiFi (IEEE 802.XX family standards, or other mobile communication technologies, or any combination thereof), global positioning system (GPS) receiver components, and/or other components. In some embodiments, communication interface 208 may provide wired network connectivity (e.g., Ethernet) in addition to or instead of a wireless interface.

Communication interface 208 may receive and transmit data in various forms. For example, communication interface 208 may receive input communications in the form of structured and/or unstructured data feeds, clickstream data, geographic locations from a positioning system, and the like. For example, communication interface 208 may be configured to receive or send data feeds in real-time from user devices or other communication services such as web feeds and/or real-time updates from one or more third party information sources. The data feeds may be continuous or unbounded with no explicit end. Examples of applications that generate continuous data may include, for example, sensor data applications, location data applications, network monitoring and performance measuring tools, clickstream analysis tools, vehicular traffic monitoring, and the like.

Communication interface 208 may also be configured to communicate data from tracking computer system 200 to other computer systems or networks. The data may be communicated in various different forms to one or more databases that may be in communication with one or more streaming data source computers coupled to tracking computer system 200.

Tracking computer system 200 may also comprise computer readable storage media 210. For example, computer storage media 210 may include system memory 206, volatile or nonvolatile memory, removable or non-removable media, implemented in any methodology or technology for storage of information such that computer readable instructions, data structures, program modules, or other data. The computer readable storage media may be non-transitory.

Additional types of memory computer storage media may include PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by tracking computer system 200. Combinations of any of the above should also be included within the scope of computer-readable media.

Computer storage media 210 may further comprise an operating system (O/S), user module 212, geo-fence module 214, item module 216, offer module 218, order module 220, constraint engine 222, status engine 224, locator module 226, and/or arrival estimator engine 228. Tracking computer system 200 may receive and store data in various databases 229, including items database 230, users database 232, status database 234, and stream database 236. The modules and engines described herein may be software modules, hardware modules, or a combination thereof. If the modules are software modules, the modules will be embodied in a non-transitory computer readable medium and processed by processor(s) 204 with computer systems described herein.

User module 212 may be configured to identify one or more descriptors associated with a user. For example, the user interacting with tracking computer system 200 may be identified as a consumer user, merchant user, or fleet user. The consumer user may be identified upon initiating an order for an item (e.g., implicit action to identify a user, etc.) or establishing a consumer user profile (e.g., explicit action to identify the user, etc.). The merchant user may be identified upon providing one or more items for ordering and delivery. The fleet user may be identified by establishing a fleet user profile (e.g., explicit action to identify the user, etc.). Each of the users may correspond to a user location and/or a user device.

User module 212 may also be configured to determine a user profile associated with a consumer, merchant, and/or fleet user. The user profile may include a user name, user device identifier (e.g., consumer user device, merchant user device, fleet user device, etc.), a static location of the user including a consumer location or a merchant location, or one or more dynamic locations of the user including a movable location identified by a positioning system corresponding with the fleet user device. In some examples, the user profile may also include data of one or more items ordered by a consumer from a merchant.

User module 212 may receive or determine user information associated with transporting the item(s) from the merchant location to the consumer location. In some examples, user information may include a transportation vehicle associated with a fleet user. The transportation vehicle may include, for example, a bicycle or car. In other examples, the transportation vehicle may include a pedestrian mode of transportation, where the fleet user will traverse areas on foot, including the area between the merchant location and the consumer location. The mode of transportation may be stored with the user profile. In some examples, the fleet user may be associated with multiple modes of delivery (e.g., walk, bike, or car). In that case, the fleet user may choose the mode of delivery for transporting one or more items when the fleet user log into the network via the fleet user device.

Geo-fence module 214 may be configured to identify one or more geographical boundaries associated with a location. For example, geo-fence module 214 may receive a static merchant location and determine a geographical boundary around the merchant location as corresponding with the geographical boundary of the merchant location. In another example, geo-fence module 214 may receive a static consumer location and determine a geographical boundary around the consumer location as corresponding with the geographical boundary of the consumer location. The geographical boundary may identify a predetermined distance from the user location outward (e.g., 300 feet, etc.).

Geo-fence module 214 (in association with locator module 226) may also be configured to receive a transmission of a locator notification when a movable location of the fleet user device enters the geographical boundary associated with the user location. For example, geo-fence module 214 may receive the transmission of the movable location of the fleet user device from locator module 226 and compare the movable location of the fleet user device with the area associated with the geographical boundary. Geo-fence module 214 may determine that the fleet user device is entering the geographical boundary when a first movable location identifies the fleet user device as outside of the geographical boundary and a second movable location (e.g., later in time) identifies the fleet user device as inside the geographical boundary. When the movable location is within the geographical boundary (e.g., based on a comparison of the location identified by the positioning system, etc.), geo-fence module 214 may be configured to generate a locator notification to identify the entrance of the fleet user device at the geographical boundary. In some examples, the locator notification may be generated by merchant or consumer user devices (e.g., operating on behalf of geo-fence module 214, etc.). For example, upon receiving the movable location of the fleet user device, a software application executing instructions at the merchant or consumer user device may compare the movable location with the geographical boundary associated with the merchant location, consumer location, location associated with the merchant or consumer user device, or another location that the consumer user identifies as the location where the item should be delivered.

Geo-fence module 214 (in association with locator module 226) may also be configured to receive a location notification of the fleet user device at a consistent time interval. The current location of the fleet user device may be determined from the locator notification to identify a direction or location of a fleet user in association with one or more geographic boundaries. The geo-fence module 214 can determine the relative delivery portion (e.g., pickup imminent, drop-off imminent, etc.).

Geo-fence module 214 (in association with locator module 226) may also be configured to receive a transmission of a locator notification when a movable location of the fleet user device exits the geographical boundary. For example, geo-fence module 214 may receive the transmission of the movable location of the fleet user device from locator module 226 and compare the movable location of the fleet user device with the area associated with the geographical boundary. Geo-fence module 214 may determine that the fleet user device is exiting the geographical boundary when a first movable location identifies the fleet user device as inside of the geographical boundary and a second movable location identifies the fleet user device as outside the geographical boundary (e.g., later in time). When the movable location is outside of the geographical boundary after being inside the geographical boundary, geo-fence module 214 may generate a locator notification to identify the exit of the fleet user device from the geographical boundary. In some examples, the locator notification may be generated by the merchant or consumer user device as well.

In some examples, geo-fence module 214 may also be configured to interact with a positioning system (e.g., GPS, etc.) to define the geographical boundary (e.g., within a predetermined area around a merchant or consumer location, etc.). For example, geo-fence module 214 may determine a latitude, longitude, radius, duration, transition types, or other information. For example, a transition type may include an event that triggers additional actions associated with the geo-fence, including when the fleet user device enters or exits the geo-fence. The geo-fence may be static or dynamic around a static location or movable location, which can account for a variance in definitions of the geo-fence (e.g., 100 foot radius vs. one-mile radius). In some examples, the definition of geo-fence may be associated with a software application installed at the user device (e.g., merchant user device) and in communication with tracking computer system 200 that can identify the radius of the geo-fence around the location of the user device.

In some examples, geo-fence module 214 may also be configured to compute the geographical boundary on the fly and/or concurrently with a determination of the location of a user device. For example, the geographical boundary may be determined as a geographical area at a threshold distance from a location (e.g., five miles from the merchant location, etc.). The fleet user device may be within the geographical boundary based in part on a real-time determination that the fleet user device is within the threshold distance of the merchant location.

Tracking computer system 200 may also comprise an item module 216. Item module 216 may be configured to determine item information. The item information may include an item name, item identifier, and location of an item (e.g., at a merchant location, etc.). In some examples, the item may correspond with a food item or perishable item that may require an expedited transportation timeline between a merchant location and a consumer location in order to maintain the freshness of the item. In some examples, the item may be transported in an insulated or temperature controlled container to help maintain the freshness as well.

Item module 216 may also be configured to determine a plurality of status identifiers associated with the item. The item may correspond with a status identifier at a single point of time. A plurality of status identifiers may be associated with the item through the transportation of the item from the merchant location to the consumer location. The plurality of status identifiers may be stored with database 229. For example, the status identifier may correspond with an item available identifier, an item ordered identifier, a pickup started identifier, a pickup imminent identifier, a drop off started identifier, or a drop off imminent identifier.

The item available identifier may correspond with an item that is available from a merchant location, but not ordered by a consumer user. The item may be registered with item module 216 and available for ordering from one or more consumer users.

The item available identifier may correspond with an item that is ordered by a consumer user from a merchant location, but not accepted by a fleet user. The item may correspond with an electronic offer to transport the item from the merchant location to the consumer location (e.g., by offer module 218), but not accepted by a fleet user device. The ordering of the item may be registered with item module 216.

The pickup started identifier may correspond with an acceptance of the electronic offer by a fleet user device. The acceptance of the electronic offer may correlate the physical transportation of the item from the merchant location to the consumer location to a particular fleet user device. Upon establishing the pickup started identifier, the movable location of the fleet user device identified by the positioning system may correspond with a home location of the fleet user device located outside of a geographical boundary associated with the merchant location.

The pickup imminent identifier may correspond with a movable location of the fleet user device entering the geographical boundary associated with the merchant location. The determination of the fleet user device entering the geographical boundary associated with the merchant location may be identified using various methods. For example, the movable location of the fleet user may be identified by an absolute position identified by the positioning system in comparison with the merchant location. In another example, the movable location of the fleet user may be determined at a first point of time outside of the geographical boundary and at a second time inside the geographical boundary. In another example, the movable location of the fleet user device may be identified by a transmission of electronic communication from a user device to tracking computer system 200 (e.g., explicit confirmation that the fleet user device arrived at the merchant location, received by communication interface 208, etc.).

The drop off started identifier may correspond with the movable location of the fleet user device exiting the geographical boundary associated with the merchant location. The determination of the fleet user device exiting the merchant location may be identified using various methods, including methods described with other status identifiers.

The drop off imminent identifier may correspond with the movable location of the fleet user entering the geographical boundary associates with the consumer location. The geographical boundary of the consumer location may be a second geographical boundary entered by the fleet user device during the physical transportation of the item. The consumer location may correspond with the consumer user that ordered the item. The determination of the fleet user device entering the consumer location may be identified using various methods, including methods described with other identifiers.

Offer module 218 may be configured to generate an electronic offer. For example, the electronic offer may include an electronic communication that identifies an item as well as an electronic offer to physically transport the item from a merchant location to a consumer location.

The electronic offer may be transmitted to a fleet user device (e.g., via text, SMS, via a software application installed at the fleet user device, etc.).

Offer module 218 may also be configured to provide an electronic offer based on a type of path corresponding with transportation of item. For example, in association with constraint engine 222, offer module 218 may be configured to determine the type of path (e.g., traversed by a motor vehicle, non-motor vehicle, or pedestrian, etc.) corresponding with the transportation of the item. The type of path may be compared with a fleet user profile to identify a subset of fleet users that match the transportation needed for the path between the merchant location and the consumer location. Offer module 218 and/or constraint engine 222 may match the transportation identified in the subset of fleet user profiles with the transportation type identified for the type of path prior to providing the electronic offer.

Offer module 218 may also be configured to broadcast the electronic offer to a subset of fleet users (associated with constraint engine 222). For example, the electronic offer may be provided to a subset of fleet users based on the type of path corresponding with transportation of the item, such that one or more fleet user devices may receive the electronic offer when the transportation needed for the path between the merchant location and the consumer location matches the transportation used by the fleet user to transfer the item.

In some examples, the broadcast of the electronic offer may be provided to an electronic message board. The fleet user devices may access the electronic message board to receive one or more electronic offers to transport items from one or more merchant locations to one or more consumer locations. The fleet user devices may accept or decline one or more electronic offers broadcast to the electronic message board.

Offer module 218 may also be configured to receive an acceptance of the electronic offer from the fleet user device. For example, when the electronic offer is transmitted directly to a fleet user device, the fleet user device may generate and transmit an acceptance of the offer to offer module 218 (e.g., a text message including “yes” or “accept,” etc.). In another example, when the electronic offer is broadcast to an electronic message board, the fleet user device may select a tool to transmit an acceptance of the offer via the electronic message board (e.g., a button to generate an electronic message to accept the offer, etc.).

Offer module 218 may also be configured to compare an estimated arrival value (e.g., calculated by the arrival estimator engine 228) and an estimated arrival threshold. The estimated arrival value may be calculated as an estimated amount of time that a fleet user would travel between a home location and a merchant location, between a merchant location and a consumer location, or between a home location and a consumer location. The estimated arrival threshold may be determined as a maximum amount of time to travel between locations (e.g., 30 minutes, etc.).

Offer module 218 may also be configured to initiate a revocation of acceptance process of the electronic offer to physically transport the item from the merchant location to the consumer location. The revocation of acceptance process may be initiated upon the comparison between the estimated arrival value and the estimated arrival threshold. For example, when the estimated arrival value exceeds the estimated arrival threshold, the revocation of acceptance process may be initiated. In another example, the revocation of acceptance process may be initiated prior to identifying a drop-off started identifier of the item (e.g., initiated with the identification of the item available identifier, item ordered identifier, pickup started identifier, pick up imminent identifier, etc.).

The revocation of acceptance process of the electronic offer may comprise one or more actions. For example, the revocation of acceptance process may include an electronic communication being transmitted to a fleet user device. In some examples, an administrator associated with the tracking computer system 200 may initiate the electronic communication, for example, to discuss the status of physically transporting the item from the merchant location to the consumer location. In some examples, the revocation of acceptance process may include transmitting an electronic communication to the fleet user device to request the fleet user to cease transporting the item or to cease traveling to the merchant or consumer location. In some examples, the revocation of acceptance process may include receiving an electronic communication from the fleet user device associated with ceasing transportation of the item and/or accepting revocation of transportation of the item. In some examples, the revocation of acceptance process may include providing a second electronic offer to a second fleet user device, where the second electronic offer is associated with requesting the second fleet user to physically transport the item from a current location of the item to the consumer location.

In some examples, the revocation of acceptance process may transmit a push notification to the fleet user device. The notification may ask for a status (e.g., to ask if the fleet user is fine or needs help). In some examples, the notification content may differ based on a delivery issue type or status of order (e.g., pickup imminent, etc.). A second notification may be transmitted to follow up with the fleet user (e.g., to identify an exact issue instead of a Boolean response including “need help” or “OK,” etc.).

The fleet user may respond to the push notification. For example, if the fleet user responds with “HELP,” the tracking computer system may provide assistance (e.g., via automated process, via a help associate, etc.). If the fleet use does not respond, the tracking computer system may provide assistance with different content (e.g., via automated process, via a help associate, etc.). If the fleet user responds and the tracking computer system keeps detecting issues, then the tracking computer system may provide assistance with different content. All of these scenarios/states may be identified and acted upon between a fleet user, fleet user device, the tracking computer system, help center, ticketing system, and/or agents.

Order module 220 may be configured to receive an order notification of an item. For example, the consumer user device may electronically contact order module 220 to initiate an order for an item located at a merchant location. The order notification may comprise an item identifier associated with the merchant location and the consumer user. The order notification may request a physical transportation of the item from the merchant location to the consumer location.

Order module 220 may also be configured to generate an order update notification associated with a plurality of status identifiers (e.g., from status engine 224 and/or status database 234). For example, the status of delivery of an item may be described in the order update notification, including one or more status identifiers and/or status descriptions. The order update notification may be transmitted to a consumer user device associated with the order notification of the item.

Constraint engine 222 may be configured to determine a subset of fleet users that can provide physical transportation for the item. For example, constraint engine 222 may determine a subset of fleet user devices that are available (e.g., logged into a network, opt in for electronic communications, etc.). In some examples, constraint engine 222 may be configured to determine a subset of fleet users that are logged in and nearby to a merchant location (e.g., within a threshold distance of the merchant location, five miles away, etc.).

Constraint engine 222 may also be configured to determine a physical path between a merchant location and a consumer location. For example, the physical path may correspond with transportation limited to a motor vehicle path (e.g., car, truck, motorized bicycle, etc.), a non-motor vehicle path (e.g., non-motorized bicycle, skateboard, etc.), or a pedestrian path (e.g., walking, climbing stairs, riding an elevator, etc.). The physical path may be identified by an administrator that has knowledge of the physical path and stored with the item database or a third party mapping or travel routing computer service.

Constraint engine 222 may also be configured to determine which fleet user device to transmit the electronic offer. For example, all fleet user devices (e.g., within a threshold distance of the merchant location, or user devices that are active, etc.) may receive the electronic offer. In another example, the type of path (e.g., motor vehicle, non-motor vehicle, or pedestrian, etc.) corresponding with the transportation of the item may be compared with a fleet user profile to identify a subset of fleet users that match the transportation needed for the path between the merchant location and the consumer location. Constraint engine 222 may match the transportation identified in the subset of fleet user profiles with the transportation type identified for the type of path.

In some examples, constraint engine 222 may also be configured to identify a subset of fleet users that match other transportation requirements. For example, the subset of fleet users may be identified by distance or travel time between the movable location of the fleet user device, size or weight of an item in comparison with the transportation mode of the fleet user (e.g., large items over a threshold weight cannot be carried by bike messengers, etc.), or other factors. Sometimes the fleet users could be chosen based on their rating as well. The constraint engine 222 may match the other transportation requirements identified in the subset of fleet user profiles with the features of transporting the item.

Constraint engine 222 may also be configured to identify a home location of one or more fleet users. For example, constraint engine 222 may identify the home location as the current movable location of a fleet user device (e.g., received from a positioning system, or ping notification from the fleet user device to constraint engine 222, etc.). In some examples, the home location may correspond with an address identified in a fleet user profile. In some examples, home locations may be determined for the subset of fleet users whose transportation matches the type of path.

Constraint engine 222 may also be configured to determine one or more closest home locations (e.g., current location, location in user profile, etc.) to the merchant location to provide the electronic offer (e.g., via offer module 218). In some examples, a subset of the fleet users with the home locations within a threshold distance may be identified and the electronic offer may be transmitted to each of the fleet user devices in the subset. The first fleet user to accept the electronic offer may be chosen to physically transport the item.

Constraint engine 222 may also be configured to restrict the fleet user device from accepting an electronic offer. For example, constraint engine 222 may restrict a fleet user device from accepting the electronic offer based on a comparison between the type of path identified in the electronic offer and a type of transportation corresponding with the fleet user profile. In another example, constraint engine 222 may provide a filtering tool at the electronic message board to limit the electronic offers available to a subset of fleet users.

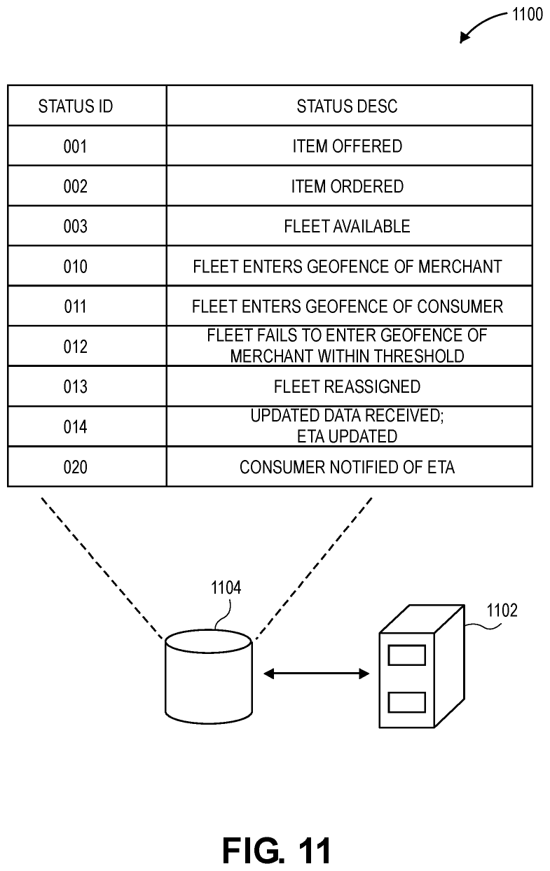

Tracking computer system 200 may also comprise status engine 224. Status engine 224 may be configured to store a status identifier of an item. For example, the status identifier may be determined by item module 216 and correspond with an item available identifier, an item ordered identifier, a pickup started identifier, a pickup imminent identifier, a drop off started identifier, or a drop off imminent identifier. The status identifier may be stored with status database 234. Additional features of the status database are illustrated with FIG. 11.

Status engine 224 may also be configured to generate status identifiers for user devices. For example, status engine 224 may be configured to generate a status identifier of a fleet user device, including entering a geographical boundary associated with the merchant location, exiting a geographical boundary associated with the merchant location, entering a geographical boundary associated with the consumer location, and the like. The status identifier may be determined based on comparing the movable location of the fleet user device with a geographical boundaries. In some examples, the status engine may generate the status identifier based on a determined status of an item, including when an item is available from a merchant user or when the item is ordered by a consumer user.

The status identifier may correspond with a delivery issue. For example, a delivery issue may be identified by comparing a time duration at a particular location with a threshold value. In some examples, the delivery issue may be identified when a movable location has failed to access a particular location (e.g., a merchant location, a consumer location, a location on a route between two locations, etc.) within the threshold value. In some examples, the delivery issue may correspond with a fleet user standing still, not moving, moving in a different direction than the merchant location or consumer location, or moving in right direction but moving slow. Each delivery issue may cause delay. In either instance, the delivery issue may be identified proactively and prior to receiving user input associated with an actual delivery issue.

The delivery issue may be identified by determining a direction of the movable location associated with the fleet user device. For example, the movable location associated with the fleet user device may be tracked based on one or more electronic communications, including the movable location identified by a positioning system. By comparing at least two of the movable locations along the time range, tracking computer system 200 may identify a direction of the fleet user device. The direction traveled by the fleet user device may be compared with an intended direction between the merchant location and the consumer location. Any discrepancies between these two directions may be identified as a delivery issue and/or an additional status identifier may be generated.

The delivery issue may be identified based on receiving updated data. For example, the tracking system may receive updated data associated with the between the home location of the fleet user, the merchant location, and consumer location. The estimated arrival time may be adjusted based on any delay identified in the updated data. The updated data may correspond with one or more delivery issues that may affect physical delivery of the item.

The status identifier of the fleet user device may correspond with a time duration. For example, the time duration may correspond with a calculated value that the movable location of the fleet user device is within a geographical boundary of the merchant location and absent exiting the geographical boundary of the merchant location. The time duration may begin when the movable location of the fleet user device enters the geographical boundary and can continue incrementing until the movable location is identified as exiting the geographical boundary.

The time duration may be compared with one or more thresholds. For example, the one or more thresholds may correspond with a maximum amount of time that the fleet user device should physically travel along a path, including between the home location or starting/current location of the fleet user device and the merchant location, between the merchant location and the consumer location, or a complete path between the home location (e.g., determined upon acceptance of the electronic offer to transport the item, etc.) and the consumer location. In some examples, the maximum amount of time may correspond with the movable location of the fleet user device being stationary or static in one location. This may identify, for example, that the fleet user is communicating with the consumer user or the merchant user in association with a delivery issue. A corresponding status identifier may be generated to identify the delivery issue. The one or more thresholds may correspond with a pickup threshold and/or drop-off threshold.

Status engine 224 may also be configured to compare values to the one or more thresholds. For example, status engine 224 may be configured to compare the time duration that the movable location of the fleet user device is within a geographical boundary and absent exiting the geographical boundary. Status engine 224 may be configured to initiate additional actions, including transmitting an electronic communication to the fleet user device associated with the transport the item and/or initiating a revocation of acceptance process.

In some examples, the additional actions may include determining a status identifier associated with the delivery issue and transmitting an issue notification to the fleet user device associated with resolving the delivery issue. For example, a description of the delivery issue may be included with an electronic communication, including a status identifier and/or description of the delivery issue. In some examples, the electronic communication may be transmitted to a fleet user device to help with resolving the delivery issue. In some examples, the electronic communication may be transmitted to a consumer user device to inform the consumer user about the delivery issue.

Status engine 224 may also be configured to update a ticketing system. For example, the ticketing system may access status identifiers stored with status database 234 and provide status identifiers to graphical user interfaces (GUI) associated with user devices. Administrative users may access the ticketing system to view the status identifiers and, in some cases, resolve any delivery issues associated with the status identifier of an item. In some examples, status engine 224 may update the status identifier associated with transportation of item proactively and prior to receiving user input from the one or more user devices, including viewing or resolving a status identifier associated with the delivery issue.

Tracking computer system 200 may also comprise locator engine 226. Locator engine 226 may be configured to identify a location of the user. For example, locator engine 226 may receive a movable location of a fleet user device from a positioning system. The positioning system may communicate with the fleet user device to trilaterate the position of the fleet user device based on an intersection point of overlapping spheres determined by positioning system satellites and fleet user device positioning system receiver. Locator engine 226 may receive the movable location of the fleet user device in a locator notification from the fleet user device.

Locator engine 226 may also be configured to receive the movable location of the fleet user device at one or more time increments. For example, the movable location may be transmitted from the fleet user device to locator engine 226 at a predetermined time interval (e.g., every 30 seconds, etc.). In some examples, the movable location of the fleet user device may be transmitted from the fleet user device to locator engine 226 upon entering or exiting geographical boundaries associated with a merchant location or consumer location (e.g., via a trigger or push notification from the fleet user device, etc.).

Locator engine 226 may also be configured to initiate a locator notification in response to receiving other notifications. For example, locator engine 226 may request the movable location of the fleet user device (e.g., via the positioning system, via the fleet user device receiver, etc.) based upon receiving an acceptance of the electronic offer to physically transport the item. This may also establish a home location of the fleet user device. In some examples, the locator notification and/or home location of the fleet user device may correspond with a time that the acceptance of the electronic offer is received.

Locator engine 226 may also be configured to determine a time duration that the movable location of the fleet user device is at a location. For example, the time duration may correspond with a movable location being within a geographical boundary and absent exiting the geographical boundary. Locator engine 226 may determine a start time that the fleet user device enters a geographical boundary (e.g., a timestamp of the locator notification, etc.) and an end time that the fleet user device exits the geographical boundary (e.g., a timestamp of the locator notification, etc.) in order to calculate the time duration that the fleet user device is within the geographical boundary.

Tracking computer system 200 may also comprise arrival estimator engine 228. The arrival estimator engine 228 may be configured to determine an estimated arrival value. For example, arrival estimator engine 228 may identify the type of path between the home location, merchant location, and consumer location (e.g., motor vehicle path, non-motor vehicle path, pedestrian path, etc.). Upon determining the type of path, a plurality of data streams may be identified to help determine the estimated arrival value. The data streams may include a number of road segments with corresponding speed limits (e.g., recommended speeds, historical average speeds, etc.), number of intersections, stop lights, and traffic signs, an average length of time to stop at the light or sign (e.g., which varies based on the type of vehicle traversing the path, etc.), average speed of the vehicle or pedestrian, any reports of traffic along the route may be identified for the path, and the like. Each time value may be aggregated to generate the estimated arrival value between two locations.

Arrival estimator engine 228 may be configured to alter the estimated arrival value for each path based on the plurality of data streams that can provide updated data to update the estimated arrival value. The data streams may include real-time traffic information from a third party data source, such that the estimated arrival value may be adjusted based on the real-time traffic data. For example, when a traffic accident is identified by the third-party data source, the ETA or estimated arrival value may be extended to account for taking a secondary path between two locations or waiting in traffic to take the original path. In some examples, arrival estimator engine 228 may transmit electronic communications with a routing server that can identify a shortest or fastest route between two locations (e.g., using a route or traffic assignment algorithm, including a Frank-Wolfe algorithm, Wardrop equilibrium algorithm, etc.).

The updated data may include order ready time of the item at the merchant location. For example, an initial order ready time may be associated with a particular item. This may include, for example, ten minutes to prepare a first dish or twenty minutes to prepare a second dish. The order ready time may be identified by the merchant user. In some examples, the order ready time may be determined based on historical order ready times or estimated order ready times for the type of item (e.g., perishable food, etc.) being prepared. The updated data can include the order ready time with an aggregation of other updated data to help determine an estimated arrival value for the item at the consumer location.

The updated data may include user input. For example, the user input may be received from the fleet user device, the merchant user device, and/or the consumer user device. The user input may identify one or more delivery issues or updates that may affect the estimated arrival value including pickup, transportation, or drop off of the item.

As a sample illustration, the fleet user device may provide an electronic communication that identifies that the particular item is not ready at the identified order ready time. Arrival estimator engine 228 may be configured to identify a timestamp associated with the generation of the electronic communication and increase the estimated arrival time in association with the timestamp of the electronic communication as well as the contents of the electronic communication. In some examples, the user input may be used to generate an updated status identifier associated with the item, which may also be used to adjust the estimated arrival value.

The updated data may include comparisons with other data or thresholds. For example, the estimated arrival value may be altered based on updated data received in association with traffic data, order ready time, and/or user input. The altered estimated arrival value may again be altered based on a comparison with other updated data as well in a continuous update of the estimated arrival value (e.g., a plurality of adjustments, etc.).

The updated data may include estimated time values associated with an initiation of a revocation of acceptance process. For example, estimated time values may be added in association with transmitting an electronic communication to the fleet user device, reassigning physical transportation of the item to a second fleet user device, providing a second electronic offer to physically transport the item from the merchant location to the consumer location, and the like.

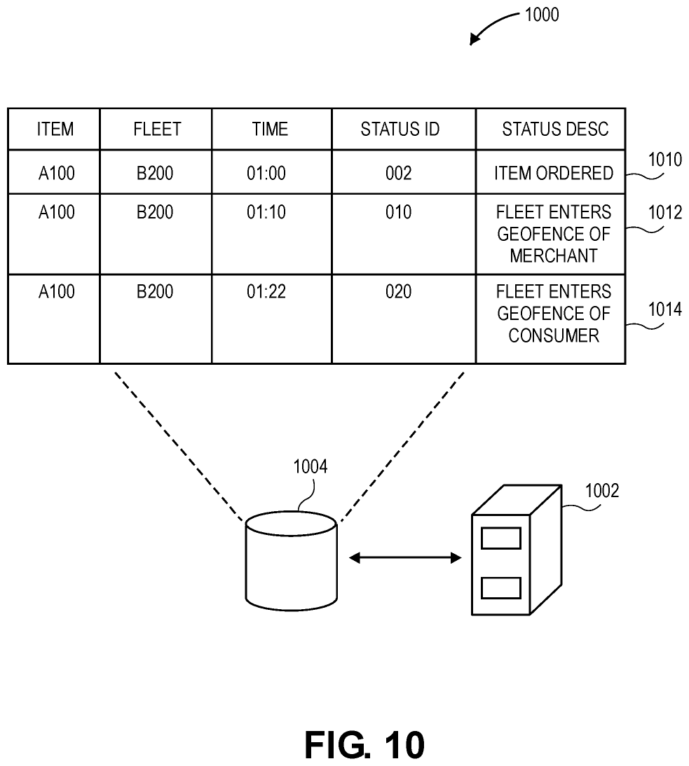

In some examples, tracking computer system 200 may also comprise item database 230. Item database 230 may comprise item identifiers, item descriptors, originating location of the item, or other relevant information. Data may be received from a data scraping process received from a merchant website, data received directly from a merchant user device, a data file received via an application programming interface (API), or other sources. Additional information associated with item database 230 may be illustrated with FIG. 10.

In some examples, tracking computer system 200 may also comprise user database 232. The user database may comprise user profiles associated with one or more users involved with facilitating delivery of an item from a merchant location to a consumer location, including name, static or dynamic location of the user, user identifier associated with fleet user, consumer user, or merchant user, user device identifier, mode of transportation (e.g., associated with a fleet user for delivery of the item, etc.), or other data. Additional information associated with user database 232 may be illustrated with FIG. 10.

In some examples, tracking computer system 200 may also comprise status database 234. Status database 234 may comprise one or more status identifiers associated with an item. Additional information associated with status database 234 may be illustrated with FIG. 11.

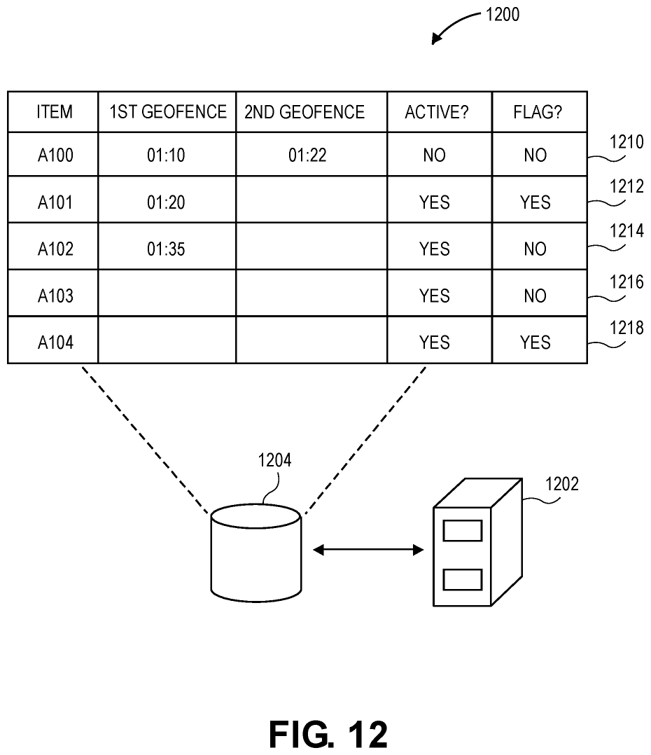

In some examples, tracking computer system 200 may also comprise stream database 236. Stream database 236 may comprise updated data associated with the transportation of an item. Additional information associated with stream database 236 may be illustrated with FIG. 12.

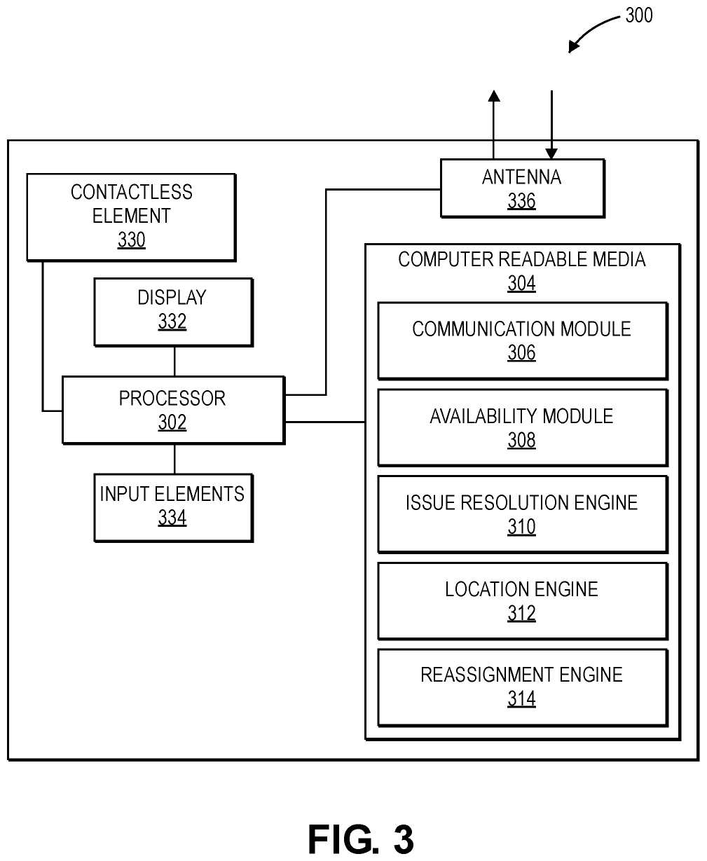

FIG. 3 is a block diagram illustrating an example of a fleet user device according to an embodiment of the disclosure. For example, fleet user device 300 may comprise hardware and software components to facilitate delivery of an item from a merchant location to a consumer user device. Fleet user device 300 may take any specialized form and/or including a mobile phone, PDA, tablet computer, laptop computer, handheld specialized device, etc. Fleet user device 300 may comprise processor 302, computer readable medium 304 including one or more engines or modules used to execute computer instructions, display 332, input elements 334, antenna 336, and contactless element 330.

Processor 302 may perform processing functions for fleet user device 300 by communicating with each subsystem and to control execution of computer instructions from computer readable media 304. Computer readable media 304 may be non-transitory. Fleet user device 300 may also include display 332 to allow fleet user to see information and electronic communications via a user interface. Input elements 334 may allow the fleet user to provide information to fleet user device 300, including viewing an electronic offer to physically transport an item and/or accepting the electronic offer by interacting with input elements 334. Fleet user device 300 may also include antenna 336 for wireless data transfer and transmissions. Contactless element 330 of fleet user device 300 may be capable of transferring and receiving near field communications in accordance with standardized protocol or data transfer mechanisms (e.g., ISO 14443/NFC). Near field communications capability may include short-range communication abilities (e.g., RFID, Bluetooth, infrared, etc.) or long-range communication abilities (e.g., electronic communications via a cellular network, etc.) that may be used to exchange data between the fleet user device and a secondary user device (e.g., merchant user device, consumer user device, tracking computer system, etc.) or the tracking computer system (e.g., via an API, etc.).

Computer readable media 304 may be in the form of a memory, where one or more modules or engines may be embodied in computer readable media 304, including communication module 306, availability module 308, issue resolution engine 310, location engine 312, and reassignment engine 314.

Communication module 306 may be configured to receive and transmit electronic messages from other computers and devices, including the tracking computer system illustrated in FIG. 1. For example, communication module 306 may be configured to receive an electronic offer to physically transport an item from the merchant location to consumer location, generate and transmit acceptance of the electronic offer to the tracking computer system, transmit a locator notification of the roof all location of the fleet user device, or transmit user input associated with delivery of an item (e.g., associated with a status identifier, etc.).

Availability module 308 may be configured to identify a fleet user as available to accept an electronic offer to physically transport an item from a merchant location to the consumer location. For example, availability module 308 may provide a selectable tool at display 332 that allows the fleet user to accept or not accept electronic offers. When the selectable tool is activated, the tracking computer system may identify the fleet user in a subset of users that are available to accept the electronic offer. The corresponding fleet user profile may be included with the determination of the tracking computer system whether to transmit the electronic offer to the fleet user device. When the selectable tool is deactivated, the fleet user device may be removed from a distribution of either a direct transmission of the electronic offer or any broadcasts of electronic offers to physically transport the item.

Issue resolution engine 310 may be configured to interact with the status engine of the tracking computer system to generate or receive electronic notifications associated with delivery issues of an item. For example, issue resolution engine 310 may receive an electronic communication identifying a delivery issue, including a status identifier associated with the delivery issue. The electronic communication may be associated with providing help to resolve the delivery issue on behalf of the fleet user device.

Location engine 312 may be configured to provide the movable location to the tracking computer system as a push notification or in response to a request from the tracking computer system. For example, antenna 336 may communicate with a positioning system to trilaterate the position of the fleet user device based on intersection point of overlapping spheres determined by the positioning system satellites.

Location engine 312 may be configured to interact with GPS or use other methods to determine its geolocation and transmit it to tracking computer system 102. If GPS is activated at fleet user device 300, the position may be accurate through electronic communications transmitted between fleet user device 300 and the positioning system. If GPS is not activated, in some examples, fleet user device 300 may use triangulation or other positioning methods where the accuracy levels may vary.

Location engine 312 may also be configured to provide a suggested path between a home location, merchant location, and/or consumer location. In some examples, location engine 312 may display a graphical user interface (GUI) with a map or provide directions between a first location and second location according to the suggested path.

Reassignment engine 314 may be configured to revoke an acceptance to physically transport the item. For example, reassignment engine 314 may decline an electronic offer to physically transport an item. In some examples, reassignment engine 314 may initiate a transfer the acceptance of the electronic offer back to the tracking computer system to reassign to a second fleet user device. Reassignment engine 314 may provide a selectable tool at display 332 that allows the fleet user to provide user input associated with a revocation of acceptance process initiated by the tracking computer system.

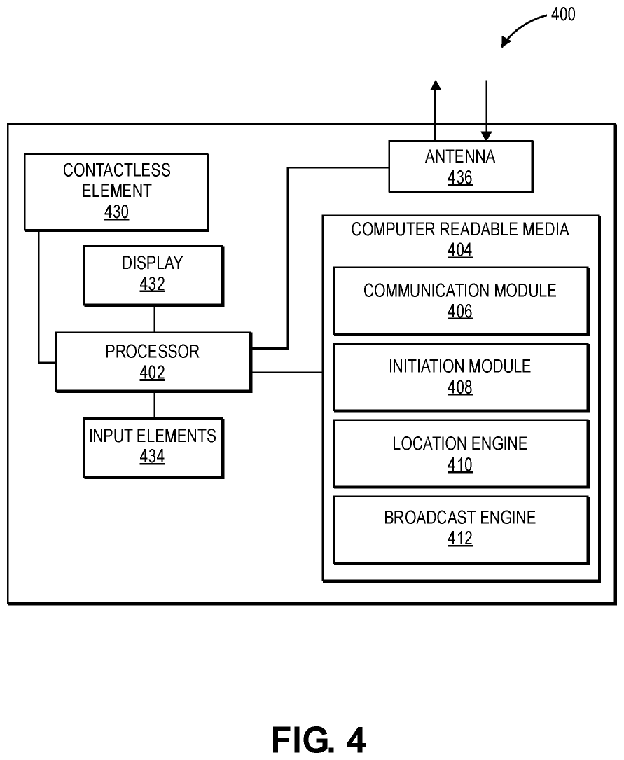

FIG. 4 is a block diagram illustrating an example of a consumer user device according to an embodiment of the disclosure. For example, consumer user device 400 may comprise hardware and software components to facilitate ordering of an item from a merchant location and delivery of the item to a consumer location. Consumer user device 400 may take any specialized form and/or including a mobile phone, PDA, tablet computer, laptop computer, handheld specialized device, etc. Consumer user device 400 may comprise processor 402, computer readable medium 404 including one or more engines or modules used to execute computer instructions, display 432, input elements 434, antenna 436, and contactless element 430.

Processor 402 may perform processing functions for consumer user device 400 by communicating with each subsystem and to control execution of computer instructions from computer readable media 404. Computer readable media 404 may be non-transitory. Consumer user device 400 may also include display 432 to allow consumer user to see information and electronic communications via a user interface. Input elements 434 may allow the consumer user to provide information to consumer user device 400, including viewing and/or accepting one or more items to order from a merchant user by interacting with input elements 334. Consumer user device 400 may also include antenna 436 for wireless data transfer and transmissions. Contactless element 430 of consumer user device 400 may be capable of transferring and receiving near field communications in accordance with standardized protocol or data transfer mechanisms (e.g., ISO 14443/NFC).

Computer readable media 404 may be in the form of a memory, where one or more modules or engines may be embodied in computer readable media 404, including communication module 406, initiation module 408, location engine 410, and broadcast engine 412.

Communication module 406 may be configured to receive and transmit electronic messages from other computers and devices, including the tracking computer system illustrated in FIG. 1. For example, communication module 406 may be configured to receive a list of the items available to order from a merchant location and provide a selection of one or more items to order. In some examples, communication modules 406 may receive one or more electronic communications from the tracking computer system associated with a status of an item, including an estimated arrival value or adjusted estimated arrival value based on one or more data streams described herein.

Initiation module 408 may be configured to initiate an order of an item by generating an order notification of the item. For example, initiation module 408 may provide a network page associated with a merchant user at display 432. The network page may include one or more items available for ordering from the merchant user. The consumer user may activate a tool to select one or more items provided with the network page. The item(s) may be included with an order from the merchant user. The order notification associated with the item may be transmitted to the tracking computer system.

Location engine 410 may be configured to determine a location of a consumer user in association with the order notification of item. Location engine 410 may identify the consumer location at the time of receiving the order notification as a static location. In some examples, the consumer location may be identified and stored with a consumer user profile prior to receiving the order notification for the item.

Broadcast engine 412 may be configured to determine a geographical boundary associated with the consumer user device by establishing a geo-fence around the location of the consumer user device or static consumer location. In some examples, the geographical boundary may be identified by interacting with a positioning system and identifying a radius of the geo-fence around the location of the consumer user device, as described herein. In some examples, the consumer location may be identified and associated with a geographical boundary unrelated to a geo-fence (e.g., a static home address, etc.).

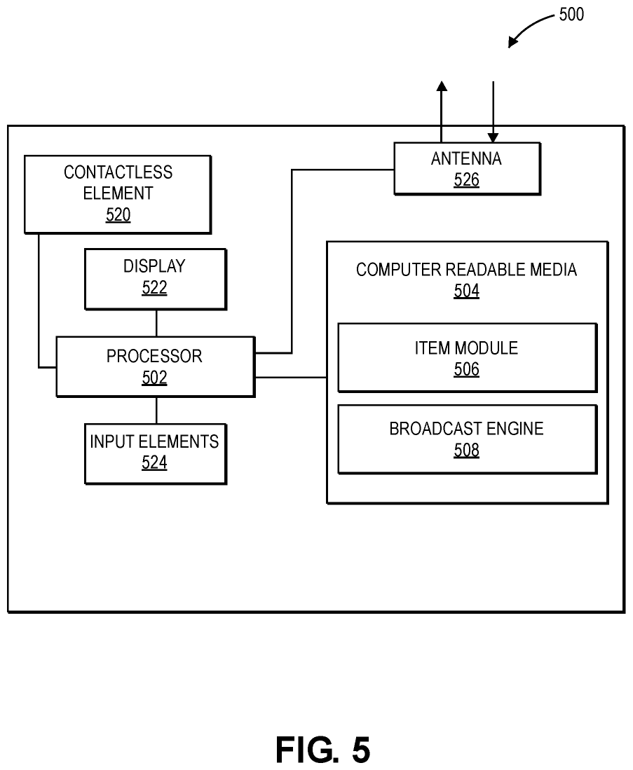

FIG. 5 is a block diagram illustrating an example of a merchant user device according to an embodiment of the disclosure. For example, merchant user device 500 may comprise hardware and software components to facilitate providing an item from a merchant location to a fleet user device for delivery to a consumer location. Merchant user device 500 may take any specialized form and/or including a mobile phone, PDA, tablet computer, laptop computer, handheld specialized device, etc. Merchant user device 500 may comprise processor 502, computer readable medium 504 including one or more engines or modules used to execute computer instructions, display 532, input elements 534, antenna 536, and contactless element 530.

Processor 502 may perform processing functions for merchant user device 500 by communicating with each subsystem and to control execution of computer instructions from computer readable media 504. The computer readable media 504 may be non-transitory.

Merchant user device 500 may also include display 532 to allow merchant user to see information and electronic communications via a user interface. Input elements 534 may allow the merchant user to provide information to merchant user device 500, including providing one or more items available to order. Merchant user device 500 may also include antenna 536 for wireless data transfer and transmissions. Contactless element 530 of merchant user device 500 may be capable of transferring and receiving near field communications in accordance with standardized protocol or data transfer mechanisms (e.g., ISO 14443/NFC).

Computer readable media 504 may be in the form of a memory, where one or more modules or engines may be embodied in computer readable media 504, including item module 506 and broadcast engine 508.

Item module 506 may be configured to receive item information associated with one or more items available for ordering from the merchant user. The item information may be displayed a network page associated with the merchant user. In some examples, the consumer user device may access the network page associated with the merchant user and identify one or more items to order from the merchant user. The item information may be transmitted to the tracking computer system by an electronic communication associated with the consumer user device. In some examples, the item information may also include a consumer location to deliver the item from the merchant location upon receiving an order for the item.

Broadcast engine 508 may be configured to determine a geographical boundary associated with the merchant user device by establishing a geo-fence around the location of the merchant user device or static merchant location. In some examples, the geographical boundary may be identified by interacting with a positioning system and identifying a radius of the geo-fence around the location of the merchant user device, as described herein. In some examples, the merchant location may be identified and associated with a geographical boundary unrelated to a geo-fence (e.g., a static home address, etc.).

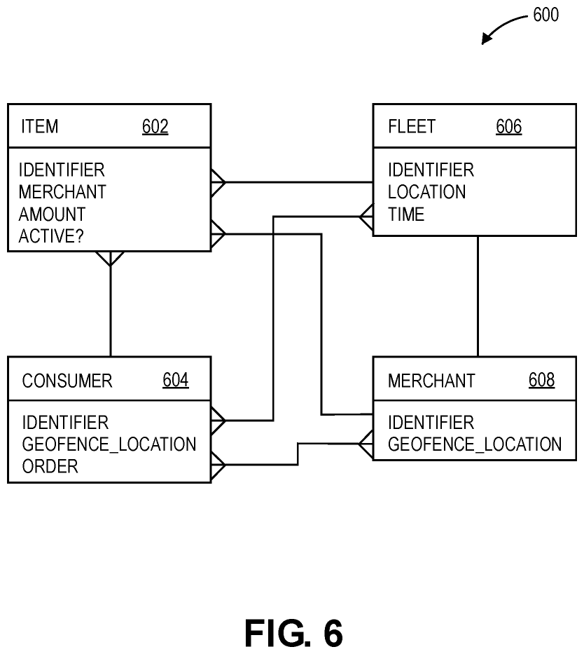

FIG. 6 is a database schema illustrating a plurality of data values according to an embodiment of the disclosure. In illustration 600, the database schema may include various data tables to identify features of the distributed system including the organization and construction of the database(s). For example, a plurality of tables in illustration 600 may include items 602, consumers 604, fleet 606, and merchants 608. These tables may include various data elements, data types, primary and unique keys, and constraints, some of which are illustrated herein, and may be implemented in a formal database language.

Item table 602 may correspond with a many-to-one relationship with consumer table 604, fleet table 606, and merchant table 608. Item table 602 may be defined by identifier data value, merchant data value, amount of an item, and a Boolean value associated with an active or non-active item (e.g., available for ordering from merchant, etc.).

Consumer table 604 may correspond with a one-to-many relationship with item table 602 and a many-to-many relationship with fleet table 606 and merchant table 608. Consumer table 604 may be defined by identifier data value, geo-fence location data value, and order data value.

Fleet table 606 may correspond with a one-to-many relationship with item table 602, a many-to-many relationship with consumer table 604, and a one-to-one relationship with merchant table 608. Fleet table 606 may be defined by identifier data value, movable location data value, and time data value.

Merchant table 608 may correspond with a one-to-many relationship with item table 602, a many-to-many relationship with consumer table 604, and a one-to-one relationship with fleet table 606. Merchant table 608 may be defined by identifier data value and geo-fence location data value.

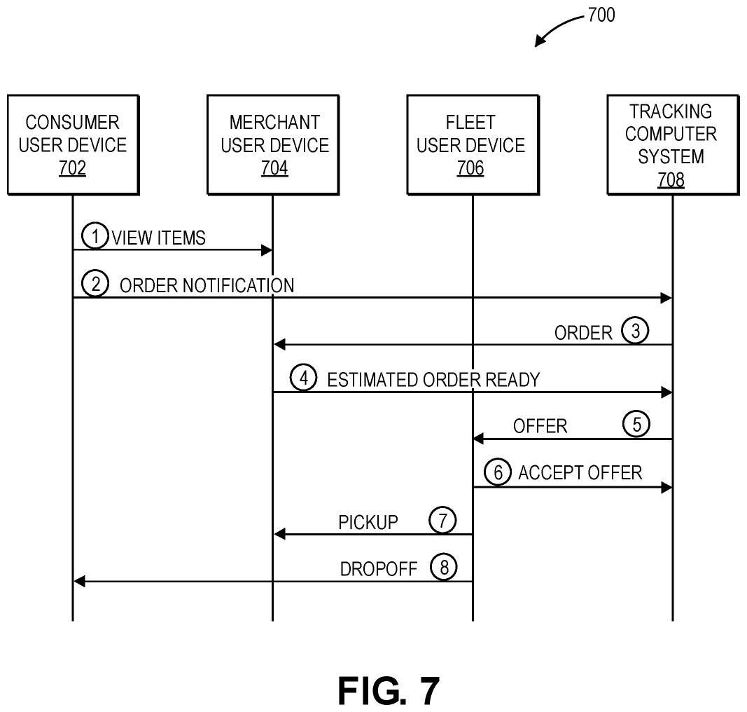

FIG. 7 is an illustrative process for facilitating a delivery of an item according to an embodiment of the disclosure. In illustration 700, a plurality of systems and devices may facilitate the delivery of the item, including consumer user device 702, merchant user device 704, and tracking computer system 708.

At step 1, consumer user device 702 may view one or more items associated with merchant user device 704. For example, the consumer user may browse to a network page or software application installed at consumer user device 702 to identify one or more items for the order. In some examples, the items may correspond with an item available status identifier.

At step 2, consumer user device 702 may provide order notification to tracking computer system 708. The order notification may be associated with one or more items located at the merchant location and associated with merchant user device 704.

At step 3, tracking computer system 708 may order the one or more items associated with merchant user device 704 and identified by consumer user device 702. In some examples, tracking computer system 708 may electronically communicate with merchant user device 704 in order to initiate in order for the item associated with consumer user device 702. In some examples, consumer user device 702 may order one or more items from merchant user device 704 and provide an order notification to tracking computer system 708 associated with the order. In some examples, the items may correspond with an item ordered status identifier.

At step 4, merchant user device 704 may identify an estimated order ready value in association with the order of the one or more items. The estimated order ready value may be provided to tracking computer system 708.

At step 5, tracking computer system 708 may identify fleet user device 706 to provide an electronic offer to physically transport item from the merchant location associated with merchant user device 704 to the consumer location associated with consumer user device 702. Tracking computer system 708 may provide the electronic offer in a direct communication to fleet user device 706 or provide a broadcast notification to a subset of fleet user devices to provide the electronic offer to physically transport the item.

At step 6, fleet user device 706 may transmit an acceptance of the electronic offer to tracking computer system 708, which is received by tracking computer system 708. The acceptance of the electronic offer may initiate a determination of a movable location of fleet user device 706.

At step 7, fleet user device 706 may initiate pickup of the item from the merchant location corresponding with merchant user device 704. Tracking computer system 708 may update the status identifier for the item to correspond with a pickup started identifier. During delivery of the item, tracking computer system 708 may further update an item status with one or more status identifiers. For example, the status identifier may correspond with a pickup imminent identifier, a drop off started identifier, or a drop off imminent identifier.

At step 8, fleet user device 706 may drop off of the item by physically transporting the item from the merchant location to the consumer location corresponding with consumer user device 702. The consumer user may receive the item when the fleet user drops off the item at the consumer location.

In some examples and at any point of time, the actual movable location of the fleet user device may be compared with an expected movable location of the fleet user device. Any discrepancies between the actual movable location and expected movable location may be identified. The estimated arrival value may be updated based on the comparison.

In some examples and at any point of time, a time corresponding with the actual movable location of the fleet user device may be compared with an estimated arrival value for the actual movable location. Any discrepancies between the time and the estimated arrival value may be identified. The estimated arrival value may be updated based on the comparison.

In some examples and at any point of time, updated data may be received. The updated data is described throughout the disclosure, including for example, traffic data, order ready time data, or user input. Any data that may delay the estimated arrival value between the actual movable location of the fleet user device and the consumer location may be identified and the estimated arrival value may be updated.

In some examples, a revocation of acceptance process may be initiated based on one or more of these comparisons. The revocation of acceptance process is described throughout the disclosure, including for example a reassignment from the first fleet user device to the second fleet user device to physically transport the item from the merchant location to the consumer location, and transmitting one or more electronic indications to the fleet user device associated with the transport of the item.

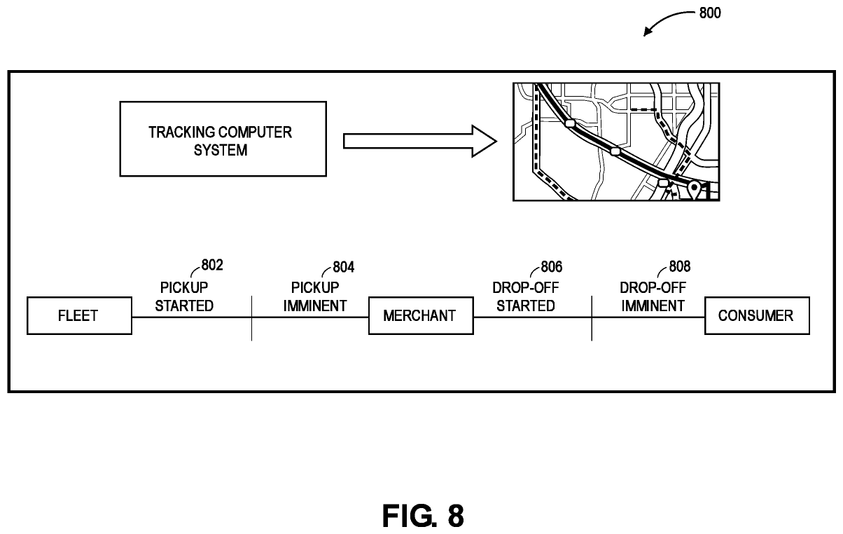

FIG. 8 is an illustrative process for determining status identifiers during a delivery of an item according to an embodiment of the disclosure. In illustration 800, the facilitation of delivery of the item may progress from pickup started 802, pickup imminent 804, a merchant location, drop off started 806, drop off imminent 808, and consumer location.

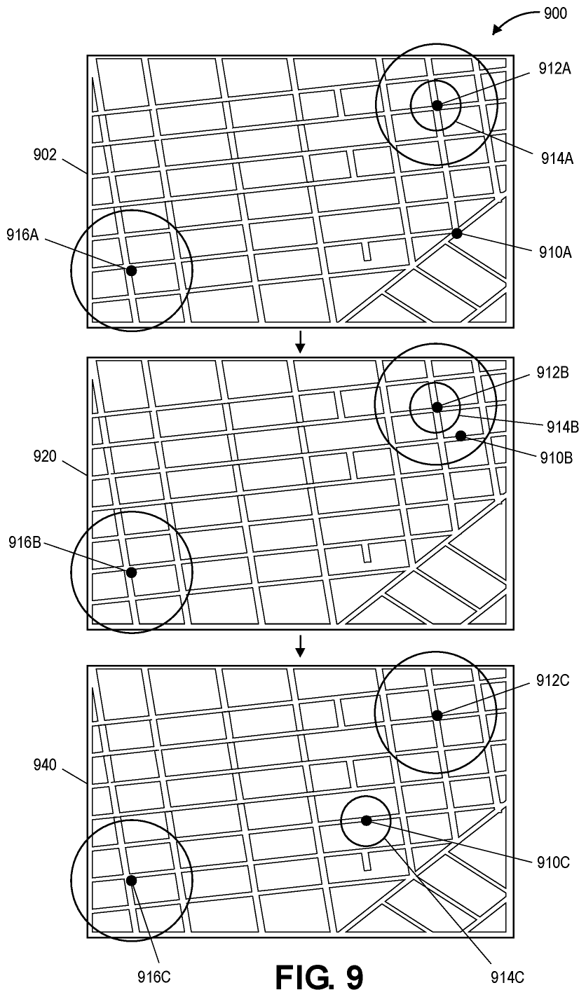

FIG. 9 is an illustrative map of geographic locations according to an embodiment of the disclosure. In illustration 900, the facilitation of delivery of an item may be provided at three points of time.

At a first time 902, the movable location of the fleet user may be transmitted to the tracking computer system. Fleet user 910A may be identified as being located outside of the geographical boundary of merchant location 912A that stores item 914A and also located outside of the geographical boundary of consumer user 916A. Fleet user 910A may traverse the distance between the fleet user location and the merchant location using a type of transportation for the path between these two points.

At a second time 920, the movable location of the fleet user may be transmitted to the tracking computer system. Fleet user 910B may be located within the geographical boundary of merchant location 912B. For example, the movable location of fleet user 910B may be transmitted from the fleet user device upon entering the geographical boundary associated with merchant location 912B (e.g., via a trigger or push notification from the fleet user device, etc.). In another example, the fleet user device may transmit the movable location via the positioning system at a predetermined interval of time.

At a third time 940, the movable location of the fleet user may be transmitted to the tracking computer system. Fleet user 910C may again be located outside of the geographical boundary of merchant location 912C. The system may determine that item 914C is stored with fleet user 910C instead of with merchant location 912C. In some examples, the tracking computer system may identify item 914C as being in the possession of fleet user 910C once the movable location of the fleet user device exits the geographical boundary of the merchant location and, in some examples, without scanning the item.

As a sample illustration, the tracking computer system receives a first movable location outside the geographical boundary and a second movable location inside the geographical boundary, within a time range. Upon receiving this series of updated data, the tracking computer system may determine that the fleet user device is entering the geographical location. When the tracking computer system receives a first movable location inside the geographical boundary and a second movable location outside the geographical boundary, within a time range, the tracking computer system may determine that the fleet user is exiting the geographical boundary. In some examples, the system may also determine that by exiting the geographical boundary associated with the merchant location, the fleet user is determined to have received item 914B while the fleet user was located within the geographical boundary of merchant location 912B. A corresponding pickup time may be associated with the item, even absent receiving user input associated with confirming that the item was picked up from the merchant location.

FIG. 10 is an illustrative database associated with status identifiers according to an embodiment of the disclosure. In illustration 1000, an item database or user database may be provided. For example, at least some of the corresponding status identifiers of the movable locations of the fleet user device from FIG. 9 are illustrated in illustration 1000. Other information may include an item identifier, a fleet identifier, a time of the status, a status identifier, and a status description.

In illustration 1000, tracking computer system 1002 may correspond with one or more tables in database 1004 that include one or more status identifiers for an item and/or one or more locations of a fleet user device. Each table row entry of database 1004 may correspond with a time entry associated with the item.

In this example, a first status entry 1010 may correspond with item A100 being ordered by consumer user and entered as a corresponding status for the item in database 1004. A second status entry 1012 may correspond with fleet user B200 entering a geo-fence of a merchant location associated with item A100. A third status entry 1014 may correspond with fleet user B200 entering a geo-fence of a consumer location associated with ordering item A100. Other status identifiers may be added to database 1004, including a status identifier of a fleet user providing an acceptance of an electronic offer to transport item identifier A100, and the like.

FIG. 11 is an illustrative database of status identifiers according to an embodiment of the disclosure. In illustration 1100, one or more status identifiers are provided for illustrative purposes and maintained by the tracking computer system 1102 in communication with one or more databases 1104. Other status identifiers are available as well without diverting from the scope of the disclosure.

For example, a status identifier may correspond with an item offered for ordering, an item ordered, a fleet user available for transporting an item, a fleet user device entering a geo-fence of the merchant, a fleet user entering a geo-fence of the consumer, a fleet user failing to enter a geo-fence of a merchant within a threshold, a fleet user being reassigned corresponding with a revocation of acceptance process, updated data being received, estimated availability value being updated, or a consumer being notified of an estimated availability value.

FIG. 12 is an illustrative item data according to an embodiment of the disclosure. In illustration 1200, a stream database is provided. The stream database may include updated data associated with a plurality of items available for physical transportation from a merchant location to a consumer location. The status of the plurality of items may be maintained by the tracking computer system 1202 in communication with one or more databases 1204.

In a first data entry 1210, a movable location of a fleet user device has entered a first geo-fence associated with the merchant location and a second geo-fence associated with the consumer location at corresponding times stored with database 1204. Upon providing item A100 to the consumer user, the item may no longer be active with the tracking computer system 1202.

When the item is no longer active, there may be no corresponding delivery issues with the item to flag, each of which are reflected with the first data entry.

In a second data entry 1212, a movable location of a fleet user device has entered a first geo-fence associated with the merchant location but not a second geo-fence associated with the consumer location. As such, the item may be active with the tracking computer system 1202. The tracking computer system 1202 may compare the time corresponding with entrance of the first geo-fence with a drop-off threshold. When the time exceeds the drop-off threshold, the physical transportation of the item may be flagged as corresponding with a potential delivery issue. Additional actions may be initiated, including transmitting an electronic communication to the fleet user device and/or initiating a revocation of acceptance process corresponding with physical delivery of the item.

In a third data entry 1214, a movable location of a fleet user device has entered a first geo-fence associated with the merchant location but not a second geo-fence associated with the consumer location. As such, the item may be active with the tracking computer system 1202. The tracking computer system 1202 may compare the time corresponding with entrance of the first geo-fence with a drop-off threshold. When the time does not exceed the drop-off threshold, the physical transportation of the item may not be flagged with a potential delivery issue. Delivery of the item may continue until an action or inaction is flagged.

In some embodiments of the disclosure, other actions or inactions may activate the flag to identify a potential delivery issue, including receiving one or more data streams that provide updated information. For example, the data streams may include traffic data, order ready time of the item at the merchant location, and/or user input received from the merchant user device, the fleet user device, or the consumer user device. Upon analysis of one or more of these data streams, a delivery issue may be identified by the tracking computer system 1202 (as explained herein) and included with database 1204.

In a fourth data entry 1216, a movable location of a fleet user device has not entered a first geo-fence associated with the merchant location. As such, the item may be active with the tracking computer system 1202 and located at the merchant location. The tracking computer system 1202 may compare the time corresponding with acceptance of an electronic offer to physically transport item from the merchant location to the consumer location with a pickup threshold. When the time does not exceed the pickup threshold, the physical transportation of the item may not be flagged with a potential delivery issue. Delivery of the item may continue until an action or inaction is flagged.

In a fifth data entry 1218, a movable location of a fleet user device has not entered a first geo-fence associated with the merchant location. As such, the item may be active with the tracking computer system 1202 and located at the merchant location. The tracking computer system 1202 may compare the time corresponding with acceptance of an electronic offer to physically transport item from the merchant location to the consumer location with a pickup threshold. When the time exceeds the pickup threshold, the physical transportation of the item may be flagged with a potential delivery issue. Additional actions may be initiated, including transmitting an electronic communication to the fleet user device and/or initiating a revocation of acceptance process corresponding with physical delivery of the item.

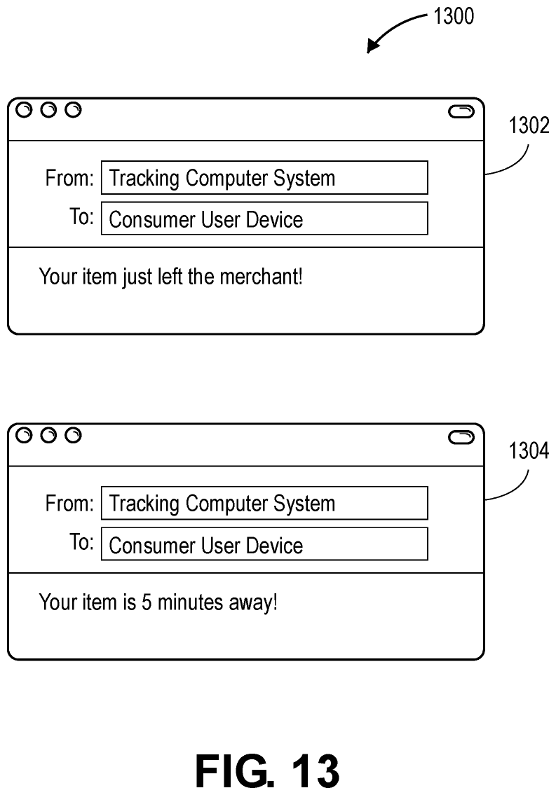

FIG. 13 illustrates notifications transmitted to a consumer user device according to an embodiment of the disclosure. In illustration 1300, the tracking computer system may provide one or more electronic communications to a consumer user device corresponding with one or more status identifiers of the item.

For example, a first electronic communication 1302 may identify that the item has left a merchant location when a corresponding movable location of the fleet user device exits the geographic boundary associated with the merchant location. In another example, the first electronic communication 1302 may correspond with user input identifying that the item has left the merchant location.

In another example, a second electronic communication 1304 may identify that the item is close to being delivered to the consumer location (e.g., within 5 minutes, within a threshold time, etc.) when the movable location of the fleet user device enters the geographic boundary associated with the consumer location. In another example, the second electronic communication 1304 may correspond with user input identifying that the item is close to being delivered to the consumer location.

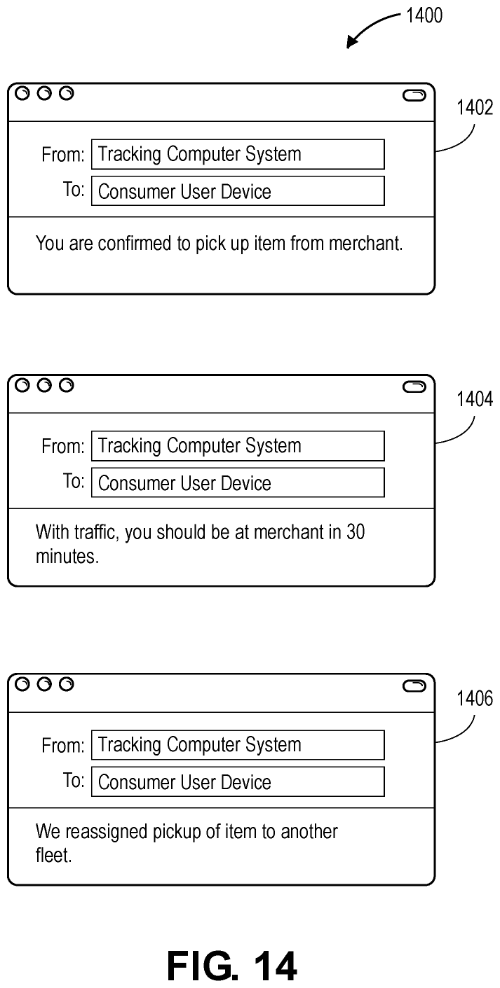

FIG. 14 illustrates notifications transmitted to a fleet user device according to an embodiment of the disclosure. In illustration 1400, the tracking computer system may provide one or more electronic communications to a fleet user device corresponding with one or more status identifiers of the item.

For example, a first electronic communication 1402 may identify that the tracking computer system has received an acceptance of the electronic offer from the fleet user device. A second electronic communication 1404 may identify that the tracking computer system has received updated data corresponding with delaying the estimated arrival value for the item physically transported by the fleet user device. A third electronic communication 1406 may identify that the tracking computer system has initiated a revocation of acceptance process from the fleet user device to a second fleet user device.

While the principles of the disclosure have been described above in connection with specific apparatuses and methods, it is to be clearly understood that this description is made only by way of example and not as limitation on the scope of the disclosure.

What is claimed is:

1. A computer-implemented method comprising:
receiving, by a tracking computer system, an order notification for an item associated with a consumer user device located at a consumer location, wherein the item is located at a merchant location, wherein a merchant user device is located at the merchant location;
providing, by the tracking computer system, an electronic offer to transport the item from the merchant location to the consumer location;
receiving, by the tracking computer system, an acceptance of the electronic offer from a fleet user device, wherein a location of the fleet user device corresponds to a movable location identified by a positioning system;
upon receiving the acceptance of the electronic offer, updating, by the tracking computer system, a status of the item to a first status identifier of a plurality of status identifiers, wherein the first status identifier corresponds to a pickup started identifier;
receiving, by the tracking computer system, a first locator notification when the movable location of the fleet user device enters a first geographical boundary of a plurality of geographical boundaries, wherein the first geographical boundary is associated with the merchant location;
upon receiving the first locator notification, updating, by the tracking computer system, the status of the item to a second status identifier of the plurality of status identifiers, wherein the second status identifier corresponds to a pickup imminent identifier;
receiving, by the tracking computer system, a second locator notification when the movable location of the fleet user device exits the first geographical boundary;
upon receiving the second locator notification, updating, by the tracking computer system, the status of the item to a third status identifier of the plurality of status identifiers, wherein the third status identifier corresponds to a drop-off started identifier;
receiving, by the tracking computer system, a third locator notification when the movable location of the fleet user device enters a second geographical boundary of the plurality of geographical boundaries, wherein the second geographical boundary is associated with the consumer location; and
upon receiving the third locator notification, updating, by the tracking computer system, the status of the item associated with the consumer user device to a fourth status identifier corresponding to a drop-off imminent identifier.

2. The computer-implemented method of claim 1, further comprising:
generating an order update notification associated with the plurality of status identifiers; and
transmitting the order update notification to the consumer user device.

3. The computer-implemented method of claim 1, wherein the electronic offer to transport the item from the merchant location to the consumer location is provided directly to the fleet user device.

4. The computer-implemented method of claim 1, wherein the electronic offer to transport the item from the merchant location to the consumer location is provided to an electronic message board accessible by the fleet user device.

5. The computer-implemented method of claim 1, wherein the item is a food item.

6. The computer-implemented method of claim 1, wherein the merchant user device initiates a transmission of the first locator notification when the movable location of the fleet user device enters the first geographical boundary.

7. The computer-implemented method of claim 1, wherein the consumer user device initiates a transmission of the third locator notification when the movable location of the fleet user device enters the second geographical boundary.

8. A tracking computer system comprising:
one or more processors; and
a non-transitory computer-readable medium including instructions that, when executed by the one or more processors, cause the one or more processors to:
receive an order notification for an item associated with a consumer user device located at a consumer location, wherein the item is located at a merchant location, wherein a merchant user device is located at the merchant location;
provide an electronic offer to transport the item from the merchant location to the consumer location;
receive an acceptance of the electronic offer from a fleet user device, wherein a location of the fleet user device corresponds to a movable location identified by a positioning system;
upon receiving the acceptance of the electronic offer, update a status of the item to a first status identifier of a plurality of status identifiers, wherein the first status identifier corresponds to a pickup started identifier;
receive a first locator notification when the movable location of the fleet user device enters a first geographical boundary of a plurality of geographical boundaries, wherein the first geographical boundary is associated with the merchant location;
upon receiving the first locator notification, update the status of the item to a second status identifier of the plurality of status identifiers, wherein the second status identifier corresponds to a pickup imminent identifier;
receive a second locator notification when the movable location of the fleet user device exits the first geographical boundary;
upon receiving the second locator notification, update the status of the item to a third status identifier of the plurality of status identifiers, wherein the third status identifier corresponds to a drop-off started identifier;
receive a third locator notification when the movable location of the fleet user device enters a second geographical boundary of the plurality of geographical boundaries, wherein the second geographical boundary is associated with the consumer location; and
upon receiving the third locator notification, update the status of the item associated with the consumer user device to a fourth status identifier corresponding to a drop-off imminent identifier.

9. The tracking computer system of claim 8, wherein the instructions further cause the one or more processors to:
generate an order update notification associated with the plurality of status identifiers; and
transmit the order update notification to the consumer user device.

10. The tracking computer system of claim 8, wherein the electronic offer to transport the item from the merchant location to the consumer location is provided directly to the fleet user device.

11. The tracking computer system of claim 8, wherein the electronic offer to transport the item from the merchant location to the consumer location is provided to an electronic message board accessible by the fleet user device.

12. The tracking computer system of claim 8, wherein the item is a food item.

13. The tracking computer system of claim 8, wherein the merchant user device initiates a transmission of the first locator notification when the movable location of the fleet user device enters the first geographical boundary.

14. The tracking computer system of claim 8, wherein the consumer user device initiates a transmission of the third locator notification when the movable location of the fleet user device enters the second geographical boundary.

15. A non-transitory computer-readable storage medium storing a plurality of instructions executable by one or more processors, the plurality of instructions when executed by the one or more processors cause the one or more processors to:
receive an order notification for an item associated with a consumer user device located at a consumer location, wherein the item is located at a merchant location, wherein a merchant user device is located at the merchant location;
provide an electronic offer to transport the item from the merchant location to the consumer location;
receive an acceptance of the electronic offer from a fleet user device, wherein a location of the fleet user device corresponds to a movable location identified by a positioning system;
upon receiving the acceptance of the electronic offer, update a status of the item to a first status identifier of a plurality of status identifiers, wherein the first status identifier corresponds to a pickup started identifier;
receive a first locator notification when the movable location of the fleet user device enters a first geographical boundary of a plurality of geographical boundaries, wherein the first geographical boundary is associated with the merchant location;
upon receiving the first locator notification, update the status of the item to a second status identifier of the plurality of status identifiers, wherein the second status identifier corresponds to a pickup imminent identifier;
receive a second locator notification when the movable location of the fleet user device exits the first geographical boundary;
upon receiving the second locator notification, update the status of the item to a third status identifier of the plurality of status identifiers, wherein the third status identifier corresponds to a drop-off started identifier;
receive a third locator notification when the movable location of the fleet user device enters a second geographical boundary of the plurality of geographical boundaries, wherein the second geographical boundary is associated with the consumer location; and
upon receiving the third locator notification, update the status of the item associated with the consumer user device to a fourth status identifier corresponding to a drop-off imminent identifier.

16. The computer-readable storage medium of claim 15, wherein the instructions further cause the one or more processors to:
generate an order update notification associated with the plurality of status identifiers; and
transmit the order update notification to the consumer user device.

17. The computer-readable storage medium of claim 15, wherein the electronic offer to transport the item from the merchant location to the consumer location is provided directly to the fleet user device.

18. The computer-readable storage medium of claim 15, wherein the electronic offer to transport the item from the merchant location to the consumer location is provided to an electronic message board accessible by the fleet user device.

19. The computer-readable storage medium of claim 15, wherein the item is a food item.

20. The computer-readable storage medium of claim 15, wherein the merchant user device initiates a transmission of the first locator notification when the movable location of the fleet user device enters the first geographical boundary.
